(19) United States
(12) Patent Application Publication
(10) Pub. No.: US 2026/0290661 A1
(43) Pub. Date: Sep. 24, 2026

(54) MODULAR ELECTRICAL RESISTANCE WITH A VOLUME CONFIGURED FOR THE CIRCULATION OF A COOLING FLUID

(71) Applicant: COUDOINT, Les Essarts Le Roi (FR)

(72) Inventor: Joël GARNAULT, Les Essarts Le Roi (FR)

(73) Assignee: COUDOINT, Les Essarts Le Roi (FR)

(21) Appl. No.: 19/490,221

(22) PCT Filed: May 28, 2024
(86) PCT No.: PCT/FR2024/050685

§ 371 Date: Dec. 4, 2025

(30) Foreign Application Priority Data
Jun. 5, 2023 (FR) FR2305632

(51) Int. Cl. H01C 7/22; H01C 1/082; H01C 17/00

(52) U.S. Cl. CPC H01C 7/22; H01C 1/082; H01C 17/00

(57) ABSTRACT

An electrical resistance extending between a first end and a second end, including a plurality of modules made of an electrically insulating material and a winding wound in turns around the modules, each of the modules having an outer peripheral surface and an inner peripheral surface, the modules being arranged side-by-side from the first end to the second end of the electrical resistance, thereby defining a volume configured for the circulation of a cooling fluid.

### DESCRIPTION

The present invention relates to the field of resistances, and more particularly to the field of resistive power loads.

The electrical resistances, or resistive dipoles, are devices used within an electrical circuit to provide resistance to the circulation of an electric current. These electrical resistances include variable electrical resistances, i.e. resistances with a variable value. Such a variation results, for example, from mechanical factors, and in particular from an increase or decrease in a dimension of the resistant body.

The rheostats are variable electrical resistances used to vary the ohmic value of a resistive element. These rheostats are dimensioned to withstand a given level of current intensity, the value of such intensity which may be adjusted. The intensity is adjusted, for example, by moving a slider along a winding of the rheostat.

In rheostats, and more generally in resistive power loads, the management of heat dissipation is essential. The resistances are generally associated with cooling devices, for example fans, which apply a flow of cooling air directed towards the winding.

However, such cooling means does not allow optimum management of heat dissipation and may also lead to space constraints. The present invention aims to overcome this disadvantage by providing an electrical resistance that may be adapted to different customer dimensional requirements, the electrical resistance also having optimized heat dissipation management.

The main object of the present invention is thus an electrical resistance extending between a first end and a second end, comprising a plurality of modules made of an electrically insulating material and a winding wound in turns around the modules, each of the modules having an external peripheral surface and an internal peripheral surface, the modules being arranged side by side from the first end to the second end of the electrical resistance defining a volume configured for the circulation of a cooling fluid.

The electrical resistance according to the invention is formed of several modules made of an electrically insulating material, such modules constituting assembly bricks which form a main body of the electrical resistance. The dimensions of the electrical resistance may therefore be easily adapted to suit customer requirements, since by adding or removing modules its extension dimension measured from its first end to its second end may be modified. The electrical resistance comprises, for example, sixteen modules arranged end to end from one end of the electrical resistance to the other.

The electrically insulating material is, for example, ceramic or alumina; generally speaking, it is a material with a resistivity greater than or equal to 1 kilo ohm per meter.

Each module is radially delimited by an external peripheral surface and an internal peripheral surface, both of which are round, square or ovoid in shape, depending on the embodiment. The external peripheral surfaces form an interface between the electrical resistance and a space outside it. The internal peripheral surfaces are radially opposite them and delimit a volume within the electrical resistance configured for the circulation of a cooling fluid, for example pressurized air or water. This volume extends around a virtual line forming a principal axis of the electrical resistance.

A winding is wound around the modules, corresponding to a resistive wire extending between the first end and the second end of the electrical resistance. More specifically, the winding is wound in turns around the modules. This is facilitated in embodiments where the external peripheral surfaces of these modules are round or ovoid in shape.

The winding, which heats up when the electric current is passed through it, is cooled when the cooling fluid circulates. The term “cooling fluid” refers to any fluid circulating within the electrical resistance and configured to exchange heat for the purpose of cooling it.

According to an optional characteristic of the invention, the electrical resistance comprises a contact device bearing against the winding and movable between the first end and the second end of the electrical resistance.

In this embodiment, the electrical resistance is a rheostat. By moving the contact device, for example a slider, along the winding from the first end of the electrical resistance to its second end, it is possible to regulate the intensity of the electrical current.

According to an optional characteristic of the invention, the electrical resistance comprises a metal element arranged within the volume delimited by the modules, the metal element being configured to channel the cooling fluid.

Within the volume delimited by the internal peripheral surfaces of the modules, the cooling fluid is more specifically channeled by a metal element. This metal element, made of copper or aluminum for example, improves heat exchange by facilitating the thermal exchange between the winding and the cooling fluid.

Alternatively, in other embodiments, the volume through which the cooling fluid flows is metal-free. The cooling fluid then circulates directly within the volume defined by the modules, channeled by the internal peripheral surfaces of these modules.

According to an optional characteristic of the invention, the metal element is at least partially pressed against at least one of the internal peripheral surfaces of the modules.

Preferably, the metal element is pressed against a majority of the internal peripheral surfaces of the modules, or even against the internal peripheral surfaces of all the modules. It is understood that the metal element and the internal peripheral surfaces have complementary shapes. Either the metal element is completely pressed against the internal peripheral surfaces, or only a portion of this metal element is in contact with the internal peripheral surfaces.

According to an optional characteristic of the invention, the metal element is composed of a plurality of modular segments.

Like the modules forming the body of the electrical resistance, the modular segments are parts that may be assembled together to form the metal element. These modular segments are arranged side by side, end to end, from the first end of the electrical resistance to its second end. The presence of modular segments facilitates deformation, in particular the expansion of the metal element during thermal exchange.

According to an optional characteristic of the invention, the metal element is a metal tube.

According to an optional characteristic of the invention, the metal element is a metal blade.

This blade is a spring blade. Thanks to its elasticity, the blade is optimally pressed against the modules to ensure the thermal exchange between them and the cooling fluid. The blade extends from one end of the electrical resistance to the other so as to facilitate the transfer of heat over an entire dimension of the electrical resistance. The blade is either substantially flat or curved.

According to an optional characteristic of the invention, at least one of the modular segments is formed by at least two hulls.

This characteristic corresponds to an embodiment wherein the metal element is a metal tube. Preferably, all the modular segments are formed by at least two hulls. Each hull has a semi-circular shape, the two hulls being joined around the virtual line forming the main axis of the electrical resistance.

According to an optional characteristic of the invention, at least one of the modular segments is formed by an annular portion of metal tube.

This characteristic corresponds to the variant embodiment wherein the metal element is a metal tube. Each modular segment is made in one-part and corresponds to a cut-out performed in a metal tube with an annular cross-section.

According to an optional characteristic of the invention, at least one of the modular segments is formed of at least two slats.

This characteristic corresponds to an embodiment wherein the metal element is a metal blade.

According to an optional characteristic of the invention, each modular segment is associated with a module.

There are at least as many modular segments as there are modules within the electrical resistance. In other words, there is at least one modular segment arranged radially within each module.

According to an optional characteristic of the invention, at least one of the modular segments has an external face facing the internal peripheral surface of the module and an internal face configured to delimit a circulation duct for the cooling fluid.

The external face of the modular segment has a complementary shape to the internal peripheral surface of the module with which it is associated, i.e. within which it is arranged. When the metal element is a metal tube, the external face and internal face of the modular segment are radially opposite. The internal face helps to delimit a circulation duct for the cooling fluid; more particularly, such a circulation duct is formed by the combination of the internal faces of the plurality of modular segments of the metal tube of the electrical resistance.

According to an optional characteristic of the invention, at least one of the modular segments is delimited axially by a first wafer and a second wafer, the modular segment comprising securing means formed from at least one of the wafers.

The first wafer and the second wafer are faces of the modular segment that connect its external face and its internal face. For example, the first wafer is oriented towards the first end of the electrical resistance, while the second wafer is oriented towards the second end of the electrical resistance. At least one of the wafers comprises means for securing the modular segments to each other or modular segments to another element of the electrical resistance. In some embodiments, the securing means comprise a leg and a recess. The leg corresponds to a portion projecting from the wafer, while the recess corresponds to a removal of material from this wafer. In other embodiments, the securing means comprise an arm and a hook.

According to an optional characteristic of the invention, two adjacent modular segments are held together by cooperation between at least one of their legs and at least one of their respective recesses.

The legs and the recesses of two adjacent modular segments have complementary shapes, so that a leg of a given modular segment fits into a recess of the modular segment adjacent to it, i.e. directly next to it. The legs and the recesses therefore form a connection between two adjacent modular segments. In this way, the modular segments are not combined around their entire circumference, but only in the areas where the legs and recesses fit together, which allows a thermal expansion of these modular segments during thermal exchange with the cooling fluid.

According to an optional characteristic of the invention, the electrical resistance comprises an attachment flange disposed at a junction between two adjacent modular segments, the securing means extending at least partially through this attachment flange.

The flange is essentially flat. It is made of metal, for example copper. It has a first contact face oriented towards the first end of the electrical resistance and a second contact face oriented towards its second end. The flange is arranged between two adjacent modular segments, and by extension between the two modules associated with these two modular segments. It forms a spacer between the modules and contributes to the mechanical strength of the electrical resistance. In some embodiments, the flange is configured to bring at least one of the modular segments closer to the internal peripheral surface of the module, i.e. to press the modular segments against the modules with which they are associated by rotating them.

Alternatively, an attachment crosspiece is disposed at a junction between two adjacent modules, and advantageously between two adjacent modular segments. The attachment crosspiece, which co-operates with reception areas in the modules, ensures optimum positioning of the modules in relation to each other. This ensures that the external peripheral surfaces of the modules are aligned with each other when the contact device is moved. Generally speaking, two adjacent modules are mechanically connected by an attachment system, a first example of which is the attachment flange and a second example of which is the attachment crosspiece.

According to an optional characteristic of the invention, the flange has a slot wherein the leg is housed.

In other words, the leg of a given modular segment is inserted through a slot provided for this purpose in the flange. The modular segment and the flange are held in position relative to each other by a bayonet system resulting from the L-shape of the leg.

According to an optional characteristic of the invention, each modular segment comprises a plurality of legs with different orientations relative to a central axis of the metal tube.

By “different orientations” we mean that the legs extend in planes that form angles of different values with the central axis of the metal tube. These different orientations help to press the modular segment against the module with which it is associated.

According to an optional characteristic of the invention, the flange comprises an external wall arranged radially between the external and internal peripheral surfaces of two adjacent modules.

The external wall of the flange delimits it radially. The flange thus has an external diameter, into which the external wall fits, a dimension of which lies between an internal diameter of a given module, into which its internal peripheral surface fits, and an external diameter of the module, into which its external peripheral surface fits.

In the embodiments where at least part of the electrical resistance is covered by a sealing member, the flange is used to hold this sealing member between the modules. The sealing member is therefore not in contact with the legs of the modular segments or the slots of the flanges. In addition, the sealing member locks the flanges in position to prevent them from rotating.

According to an optional characteristic of the invention, the metal element is formed in one-part from the first to the second end of the electrical resistance.

This is a variant embodiment wherein the metal element is made in one-part. A one-part metal element reduces the machining and assembly operations required to obtain electrical resistance.

According to an optional characteristic of the invention, the electrical resistance comprises at least one heat transfer device which extends at least partly within the volume delimited by the modules.

The heat transfer device helps to improve the thermal exchange between the cooling fluid and the winding. It acts as a drain to recover heat and/or dissipate it. This heat transfer device is positioned either directly against the modules or, if necessary, in the space delimited by the metal tube. This heat transfer device consists, for example, of a plurality of copper platelets arranged crosswise within the metal tube.

According to an optional characteristic of the invention, at least one opening is provided within the metal blade.

The effect of such an opening is to facilitate the circulation of the cooling fluid on either side of the blade and thus increase the exchange of heat within the volume delimited by the modules.

According to an optional characteristic of the invention, the transfer device comprises a first portion extending radially within at least one module and a second portion in contact with the metal tube.

The first portion, for example, is dedicated to dissipating calories, while the second portion is dedicated to capturing these calories. The second portion is in physical contact with the internal face of the metal tube. For example, the heat transfer device is pressed against the metal tube to receive its heat and transfer it to the cooling fluid.

As an optional characteristic of the invention, the electrical resistance comprises a sealing member covering at least the external peripheral surfaces of the modules.

Such a sealing member is, for example, a layer of cement, enamel or silicone. It structures the electrical resistance and smoothes the external peripheral surfaces for better winding adhesion. The sealing member may also be inserted between two adjacent modules, overlapping the flanges.

According to an optional characteristic of the invention, at least one of the modules is composed of at least two hulls.

Preferably, all the modules are made up of at least two hulls. Each hull has a semi-circular shape, the two hulls of the same module being joined around the virtual line forming the main axis of the electrical resistance.

According to an optional characteristic of the invention, the modules are annular sections.

Each module is made in one-part and has the shape of a closed circle.

According to an optional characteristic of the invention, at least one cavity is provided between the external peripheral surface and the internal peripheral surface of at least one of the modules, the heat transfer device being arranged at least partially in the cavity.

It is understood that the cavity is arranged radially in one thickness of the module. The cavity has, for example, an upper wall complementary in shape to the external peripheral surface and a lower wall complementary in shape to the internal peripheral surface. Each module comprises eight cavities, for example.

The cavity constitutes a housing for receiving a heat transfer device; it is understood that the heat transfer device extends at least partly within it.

According to an optional characteristic of the invention, the cavity is filled with a sealing member.

Such filling is carried out, for example, by syringe injection, the heat transfer device being inserted into the sealing member after injection.

According to an optional characteristic of the invention, the electrical resistance has a generally rectilinear shape.

According to an optional characteristic of the invention, the electrical resistance has a generally toroidal shape.

These are two variant embodiments of the electrical resistance. In its general rectilinear form, the modules have edges extending in parallel planes. In its generally toroidal form, at least one of the edges of the modules extends in an oblique plane with respect to a principal direction of elongation of the module concerned, whether this be curved or straight. In other words, the edge or edges of a given module extends in planes at an angle to a central axis of said module, which axis may be formed by a curve or a straight line. The edges of the modules extend, for example, in planes secant to such a central axis of the torus, in particular forming an angle of between 20° and 90° between these two planes. In the case of a rectilinear central axis, an angle formed between this central axis of the module and the plane passing through an edge of said module is between 30° and 80°.

The electrical resistances of generally rectilinear shape are easy to manufacture. The electrical resistances with a generally toroidal shape offer advantages in terms of compactness, with a greater number of turns for reduced packaging.

According to an optional characteristic of the invention, the general toroidal shape of the electrical resistance is square in cross-section.

This square or quasi-square cross-section allows to increase the length of the turns of the winding of the electrical resistance and to increase the cross-section of the passage of the cooling fluid within the electrical resistance. Alternatively, the overall toroidal shape of the electrical resistance is circular in cross-section. The shape of the cross-section of the electrical resistance depends on the round or square shape of the external peripheral surfaces of the modules.

According to an optional characteristic of the invention, each of the modules has indentations complementary to the adjacent modules.

Such indentations allow the modules to be angularly associated and also prevent the winding from jamming at an interface between two adjacent modules. Alternatively, gorges are provided on the external peripheral surface of the modules, the winding being housed in the gorges to fix the position of its turns. This prevents one winding turn coming into contact with an adjacent turn.

According to an optional characteristic of the invention, the electrical resistance comprises a first end plate associated with the first end and a second end plate associated with the second end.

These end plates are made of epoxy, for example, and may be lined with a metal plate each, to which they are secured by screwing.

According to an optional characteristic of the invention, the electrical resistance comprises at least one holding member, at least one of the modules being held against an adjacent module by the holding member.

The holding member takes the form of a clip or hook, for example. In particular, it consists of a straight central portion, curved at both ends so that it may be attached to an adjacent module.

According to an optional characteristic of the invention, the electrical resistance comprises at least one cable extending from the first end to the second end of the electrical resistance, passing through the modules.

The cable acts as a safety device against violent manipulation of the electrical resistance. It holds the modules together. Preferably, the electrical resistance has two cables each arranged at one end of a diameter of the electrical resistance.

The invention also relates to a method for assembling an electrical resistance as described above, comprising a step of assembling the modules during which the modules are butt-jointed and a winding step during which the winding is wound in turns around the modules.

The assembly method produces an electrical resistance in accordance with the invention. The assembly step involves the association of the modules together. The modules are then surrounded by the winding during the winding step.

According to an optional characteristic of the invention, the assembly method comprises a step of covering the modules with the sealing member.

The covering step comprises, for example, a smoothing operation to obtain an even surface to support the winding.

According to an optional characteristic of the invention, the assembly step comprises a relative rotation between a modular segment and a flange so as to press the modular segment against a module and secure the modular segment and the flange along a virtual line forming the axis of the electrical resistance.

According to an optional characteristic of the invention, during the assembly step each of the modules is assembled to an adjacent module by means of a holding member.

To this end, the holding member of a given module cooperates with a cylinder of an adjacent module, the cylinder being inserted into the curved portion of the holding member to make the modules secured.

According to an optional characteristic of the invention, the assembly method comprises, prior to the assembly step, a step of cutting the modules from a tube of electrically insulating material.

The cutting step is performed in a straight tube. The cut is made straight when the general shape of the electrical resistance is rectilinear, and the cut is made at an angle when the electrical resistance is generally toroidal. The modules are therefore straight sections. It is the assembly of the electrical resistance, in combination with the cutting angle, that gives it its overall straight or toroidal shape. Alternatively, the modules may be generally arc-shaped.

A similar cutting step is performed in a metal tube or blade when the metal element of the electrical resistance is composed of a plurality of modular segments.

Other characteristics, details and advantages of the invention will become clearer on reading the following description, on the one hand, and examples of embodiments given by way of indication and non-limitation with reference to the annexed drawings, on the other hand, wherein:

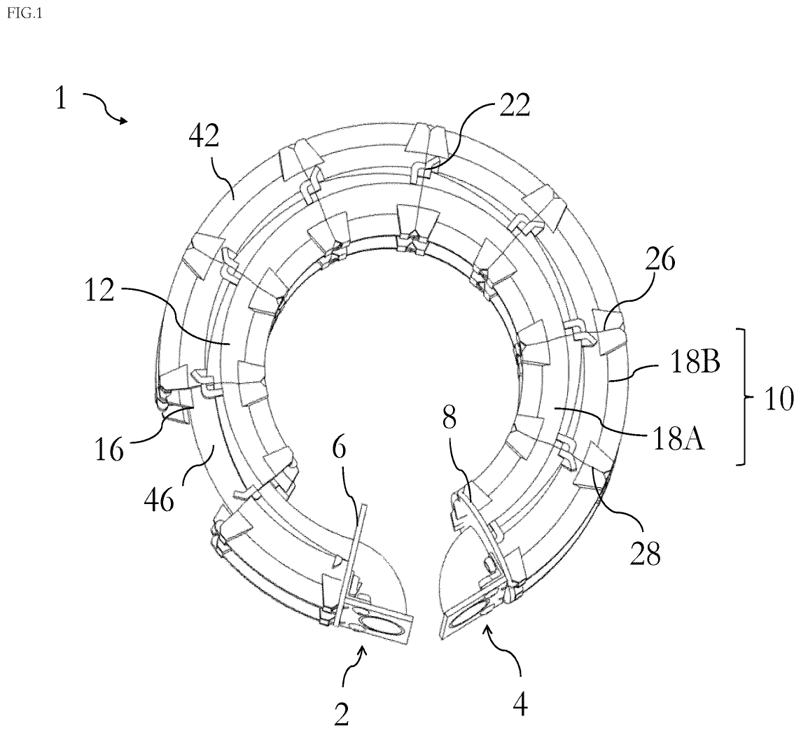

FIG. 1 schematically illustrates an electrical resistance according to a first embodiment of the invention;

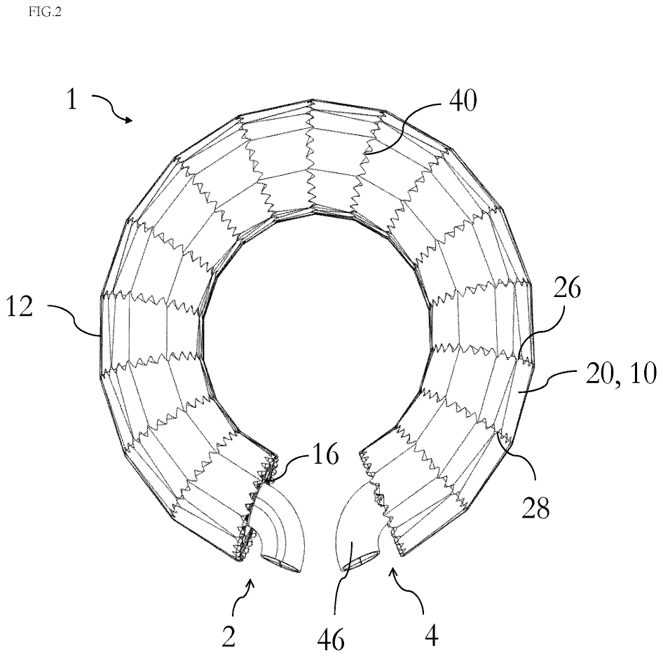

FIG. 2 schematically illustrates an electrical resistance according to the invention in a second embodiment, wherein the modules are sections;

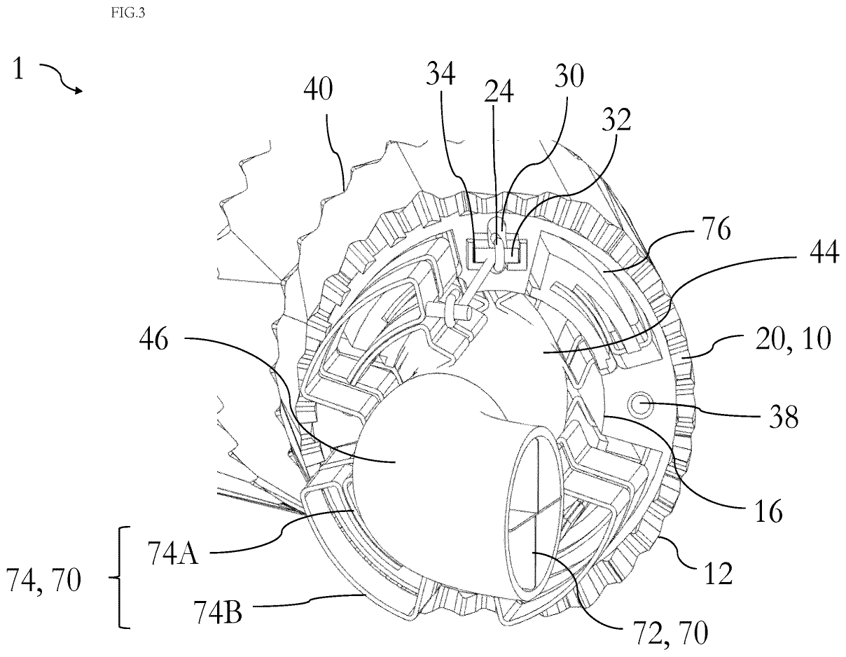

FIG. 3 schematically illustrates a close-up view of a portion of the electrical resistance in FIG. 2, one of the sections having been removed;

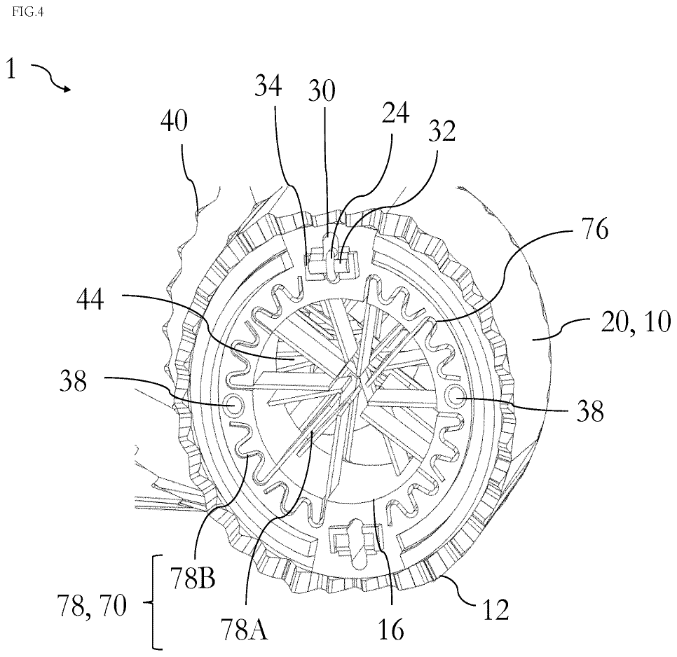

FIG. 4 schematically illustrates a close-up view of a portion of an electrical resistance in a third embodiment;

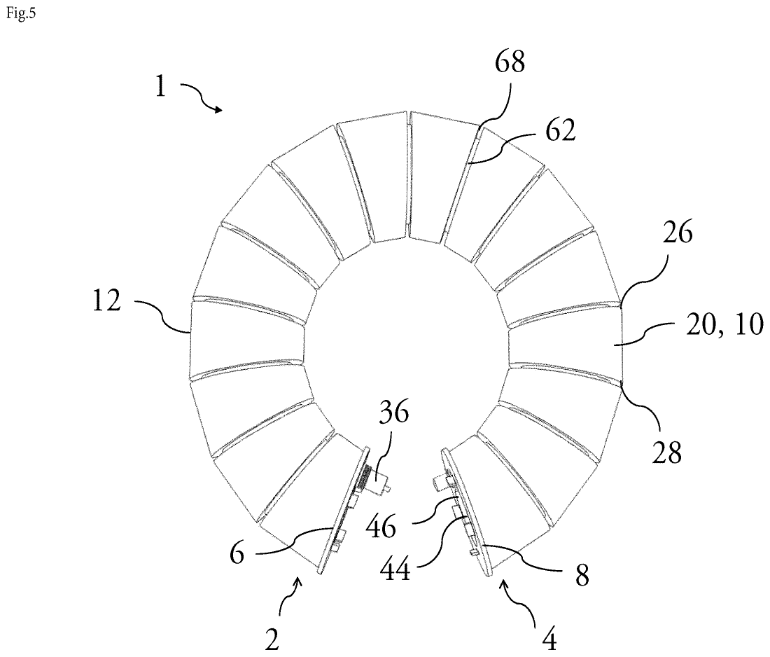

FIG. 5 schematically illustrates an electrical resistance according to the invention, in a fourth embodiment;

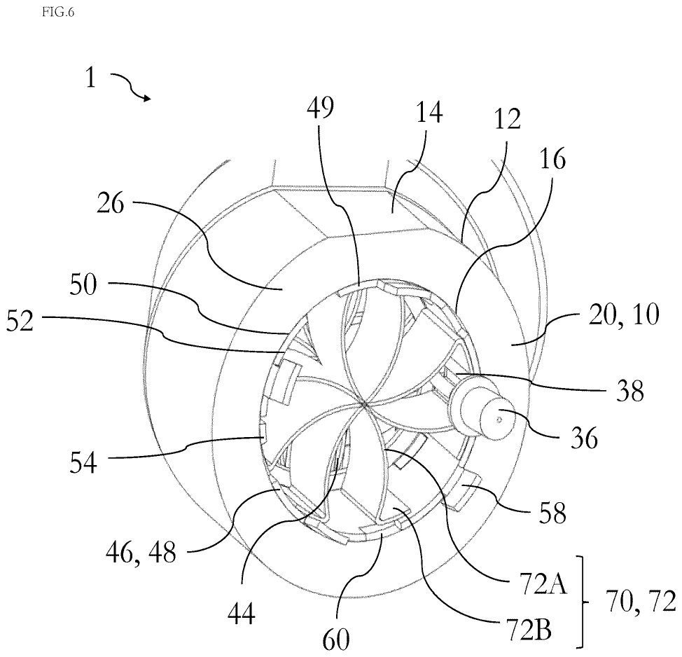

FIG. 6 schematically illustrates a close-up view of a portion of the electrical resistance in FIG. 5;

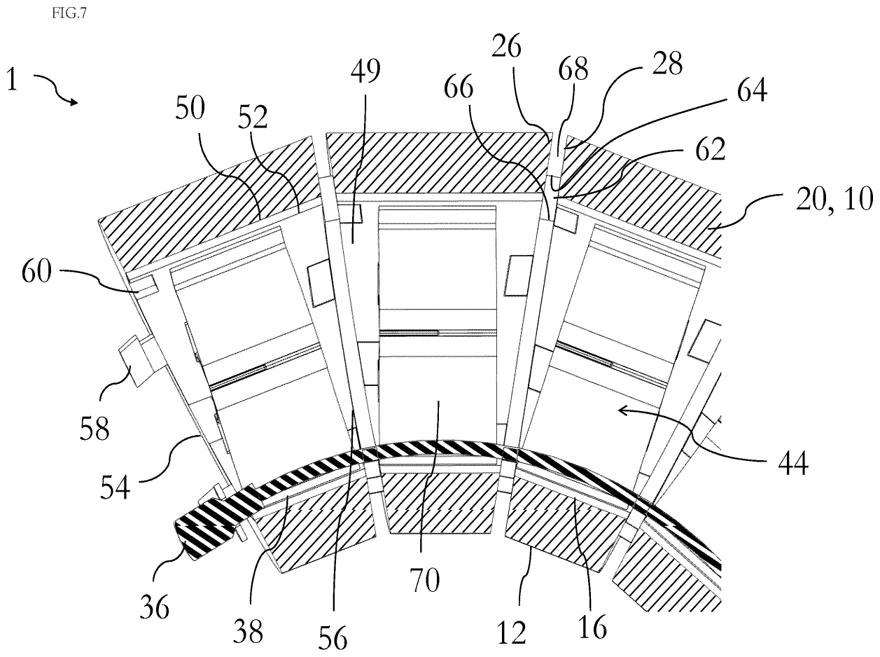

FIG. 7 schematically illustrates a cooperation between different modules and different modular segments of the electrical resistance shown in FIG. 5;

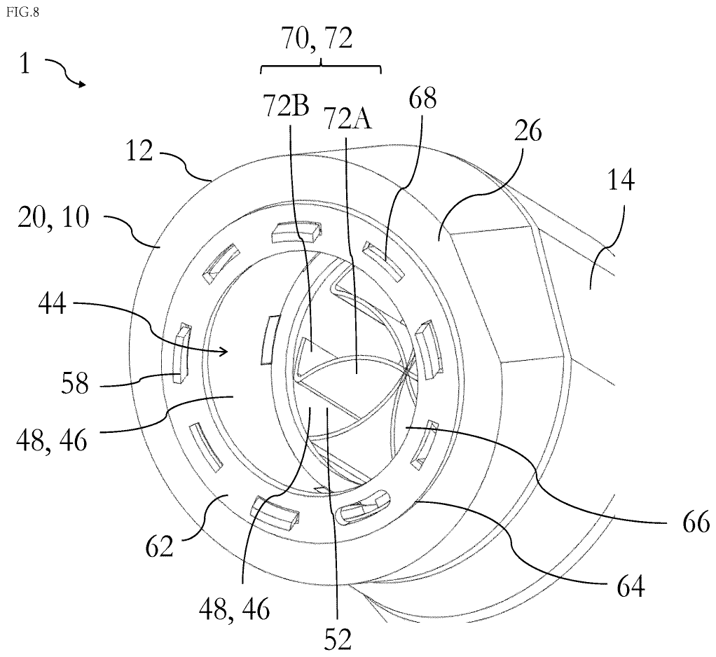

FIG. 8 illustrates, schematically, a cooperation between a flange and a modular segment of the electrical resistance of FIG. 5;

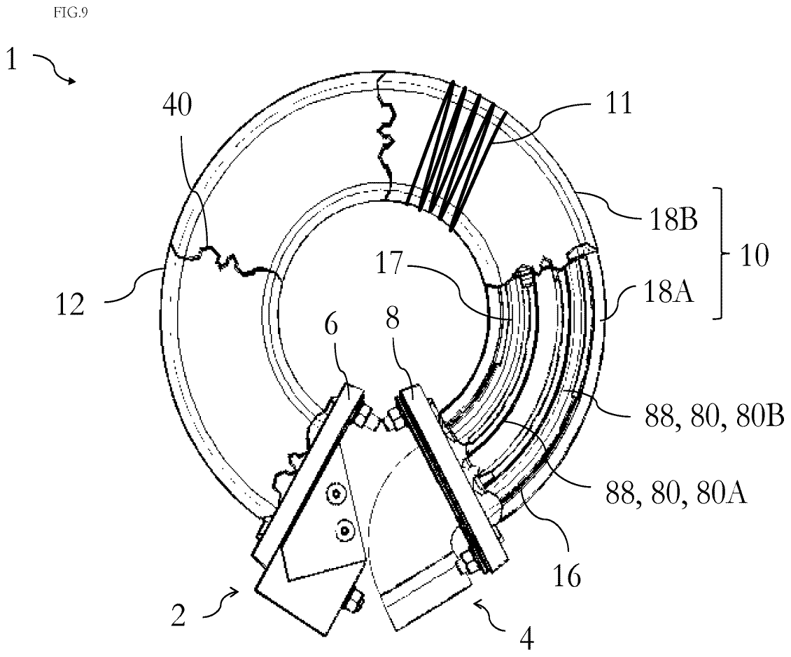

FIG. 9 schematically illustrates an electrical resistance according to the invention, in a fifth embodiment wherein the electrical resistance is provided with a metal element in the form of a metal blade;

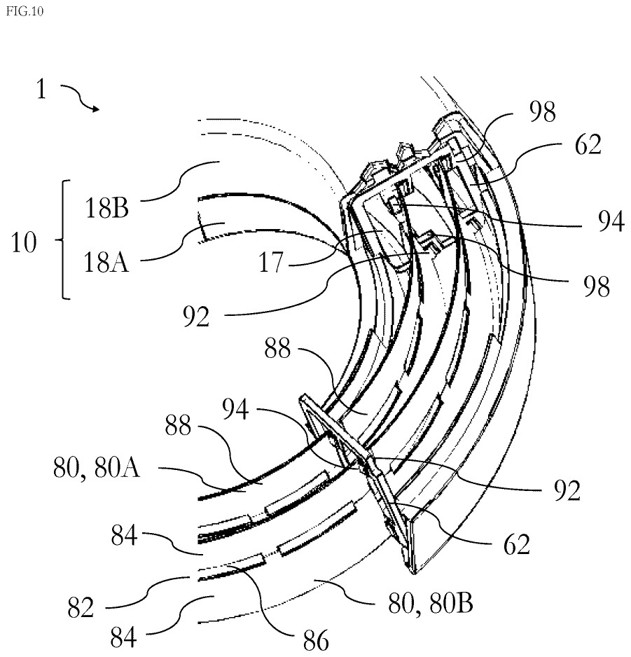

FIG. 10 schematically illustrates a portion of the electrical resistance in FIG. 9;

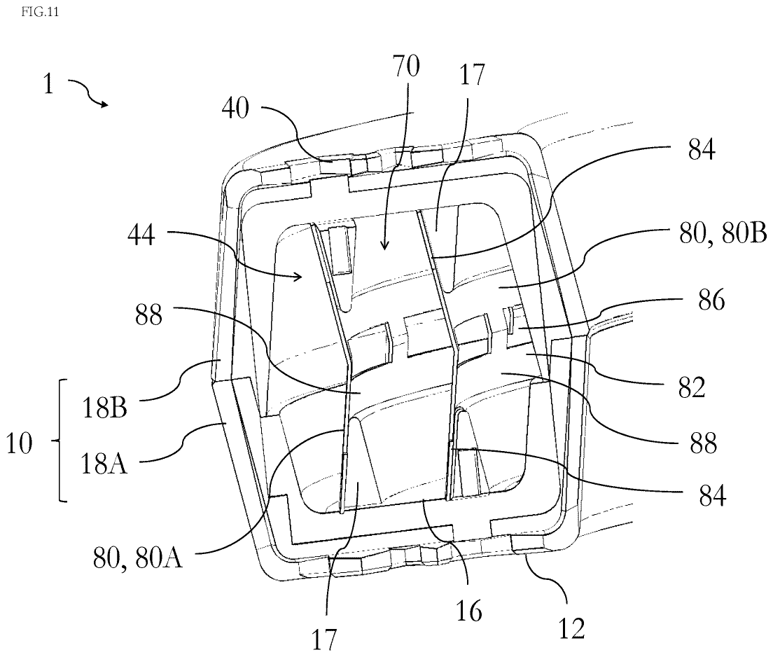

FIG. 11 shows, schematically, a cross-sectional view of the electrical resistance in FIG. 9;

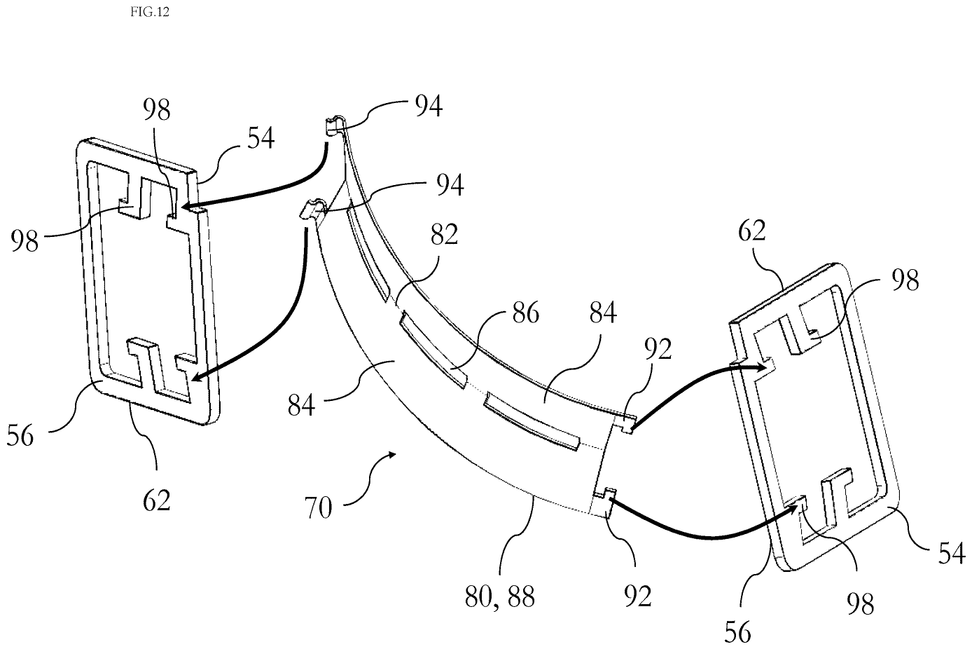

FIG. 12 illustrates, schematically, an association between an attachment flange and the metal blade of the electrical resistance of FIG. 9;

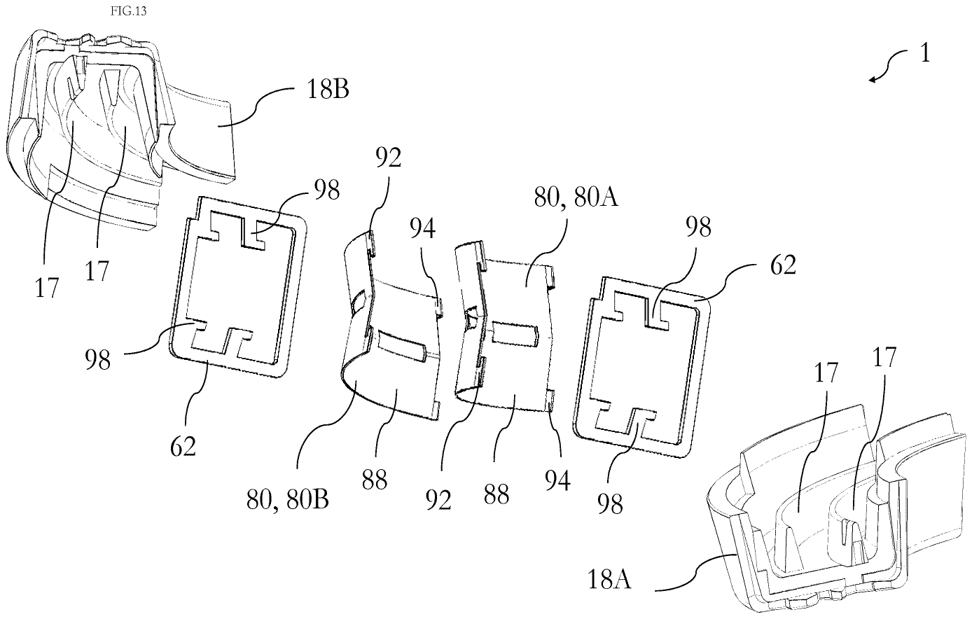

FIG. 13 shows, schematically, an exploded view of the electrical resistance in FIG. 9;

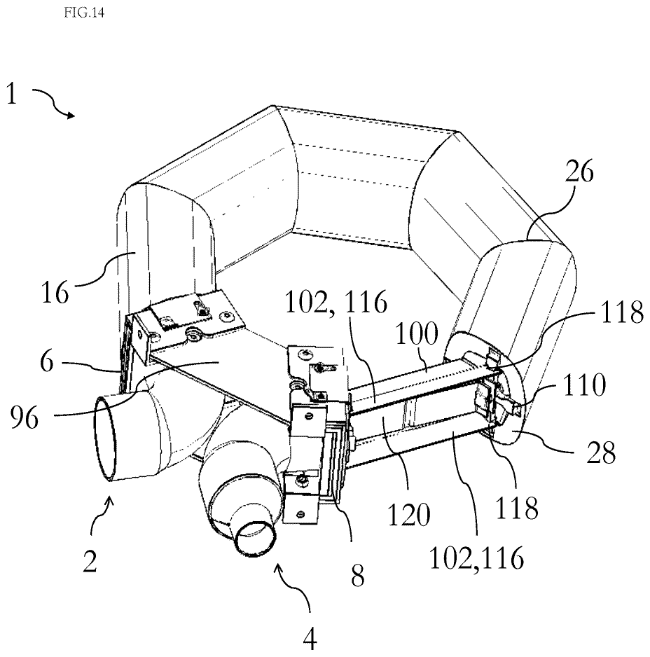

FIG. 14 schematically illustrates an electrical resistance according to the invention in a sixth embodiment;

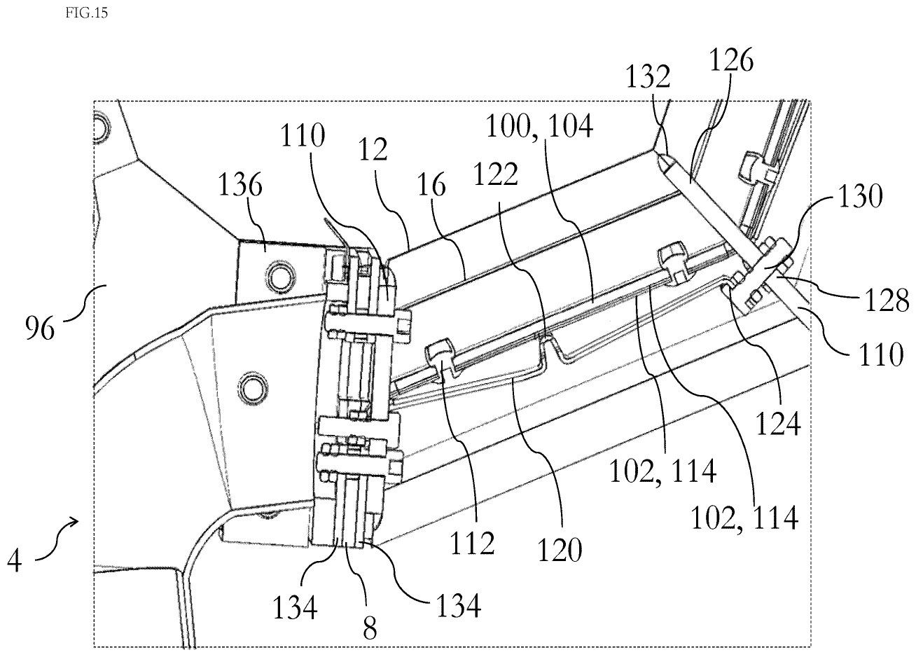

FIG. 15 schematically illustrates a cross-sectional view of a portion of the electrical resistance shown in FIG. 14;

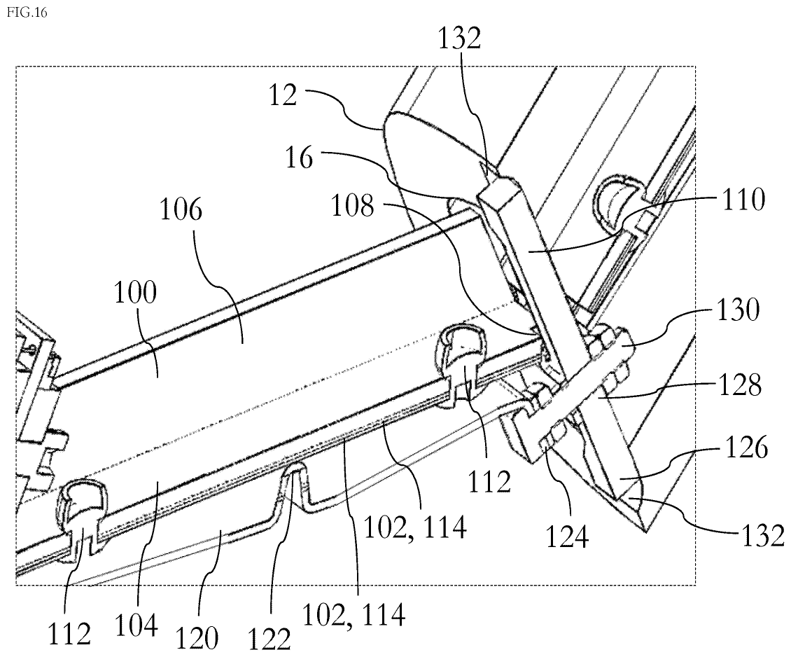

FIG. 16 schematically illustrates a close-up view of a portion of the electrical resistance in FIG. 14.

The characteristics, variants and the different embodiments of the invention may be associated with one another in various combinations, insofar as they are not incompatible or mutually exclusive.

In particular, it will be possible to imagine variants of the invention comprising only a selection of characteristics described hereinafter in isolation from the other characteristics described, if this selection of characteristics is sufficient to confer a technical advantage and/or to differentiate the invention from the prior art.

In the figures, the elements common to several figures retain the same reference.

FIGS. 1 to 16 schematically illustrate an electrical resistance 1 according to the invention. The electrical resistance 1 is a rheostat, for example. This electrical resistance 1 is shown in a first embodiment in FIG. 1, in a second embodiment in FIGS. 2 and 3, in a third embodiment in FIG. 4, in a fourth embodiment in FIGS. 5 to 8, in a fifth embodiment in FIGS. 9 to 13 and in a sixth embodiment in FIGS. 14 to 16. The characteristics described in relation to any of these embodiments may be applied, mutatis mutandis, to any of the other embodiments insofar as this is not incompatible.

The electrical resistance 1 shown in the figures is generally toroidal. However, without going beyond the scope of the invention, it is possible to imagine an electrical resistance 1 with a generally rectilinear shape. Depending on the embodiment, the electrical resistance has either a square or polygonal cross-section, as is the case in the embodiment of FIGS. 9 to 13, or a circular or oval cross-section, as is the case in the embodiments of FIGS. 1 to 8 and 14 to 16. The electrical resistance 1 extends between a first end 2 and a second end 4, either in a completely straight line or in a completely toroidal shape. In the latter case, the torus may comprise at least one straight module or one module curved along an arc of a circle, and advantageously a plurality of straight modules or modules curved along an arc of a circle. Each of these ends 2, 4 is equipped with an end plate 6, 8; there is thus a first end plate 6 arranged at the first end 2 and a second end plate 8 arranged at the second end 4, these end plates 6, 8 being visible in particular in FIGS. 1, 5, 9, 14 and 15.

As the electrical resistance 1 is configured to circulate a cooling fluid, each of the end plates 6, 8 is connected to a cooling fluid circuit. The first end plate 6, for example, is connected to a cooling fluid inlet duct, while the second end plate 8 is connected to a cooling fluid outlet duct. Filtration devices, such as grids, may be arranged at an interface between these cooling fluid inlet and outlet ducts on the one hand and the end plates 6, 8 on the other, in order to prevent the introduction and/or passage of foreign bodies within the electrical resistance 1.

The electrical resistance 1 consists of a plurality of modules 10 made of an electrically insulating material, in particular ceramic or alumina. These modules 10, whose configurations vary according to the embodiments, are arranged side by side, i.e. end to end, from the first end 2 to the second end 4 of the electrical resistance 1. In other words, the modules 10 are assembled one after the other from the first end 2 of the electrical resistance 1 to its second end 4 to form its main body. A winding 11, a portion of which is illustrated in FIGS. 5 and 9, is wound around the modules 10 in the form of turns, this winding 11 being wound from the first end 2 to the second end 4.

An interface between the electrical resistance 1 and a space outside it corresponds to an external peripheral surface 12 of the modules 10. In other words, the external peripheral surfaces 12 radially delimit the modules 10. These external peripheral surfaces 12 are substantially round or oval in shape for the embodiments shown in FIGS. 1 to 8 and 14 to 16, and substantially square in shape for the embodiment shown in FIGS. 9 to 13.

When the electrical resistance 1 is a rheostat, in the embodiments shown in FIGS. 1 to 8 and 14 to 16 the external peripheral surfaces 12 have a round or oval shape with the exception of a flat portion 14 provided along the modules from the first end 2 of the electrical resistance 1 to its second end 4, such a flat portion 14 allowing the displacement of a contact device of the electrical resistance 1 bearing against the winding 11. The flat portion 14 may be seen in FIG. 6. It is obtained by machining the modules 10, for example by sanding. In contrast, in the embodiment shown in FIGS. 9 to 13, the external peripheral surfaces 12 are square in shape, so machining is not required to provide a portion for moving a contact device of the electrical resistance 1 against the winding 11. Such a movement is then made along one of the four faces of the external peripheral surfaces 12 of the modules 10, this number of four faces resulting from the square shape of the external peripheral surfaces 12. The contact device, not shown in the figures, may be moved from the first end 2 to the second end 4 in order to regulate the intensity of the electric current flowing through the electrical resistance 1.

At the interfaces between the end plates 4, 6 and the modules 10, the electrical resistance 1 comprises metal collars, not illustrated in the figures, these metal collars extending around the external peripheral surfaces 12 so as to ensure the electrical contacts between the modules 10 and the end plates 4, 6. In some embodiments, these metal collars are continuous all around the modules 10. In other embodiments, they have a solid portion facing, depending on the case, the flat portion 14 or the face receiving the contact device, and a portion provided with open areas on the other faces of the external peripheral surfaces 12. The solid portion facing the flat portion 14 or the face receiving the contact device ensures optimum electrical contact with the contact device, while the portion provided with open areas has a securing function which will be discussed later.

The modules 10 are also delimited by an internal peripheral surface 16, which is radially opposite the external peripheral surface 12. This internal peripheral surface 16 has a round or square shape depending on the embodiments. A distance measured between the external peripheral surface 12 and the internal peripheral surface 16 of a given module 10 corresponds to its thickness, such distance being measured at the external peripheral surface 12 and the internal peripheral surface 16. In the fifth embodiment shown in FIGS. 9 to 13, the internal peripheral surfaces 16 comprise ribs 17. These ribs 17 are protrusions of the internal peripheral surfaces 16 which extend from the first end 2 to the second end 4 of the electrical resistance 1.

As mentioned above, the modules 10 have different configurations depending on the embodiments. The modules 10 are thus in the form of hulls or half-hulls 18 in the first and fifth embodiments, while they are formed by annular sections 20 in the second, third, fourth and sixth embodiments. It is understood that in the form of half-hulls 18, a given module 10 is made up of at least two parts, whereas in the form of an annular section it is made in one-part.

The modules 10 are in the form of two half-hulls 18 in the first embodiment shown in FIG. 1. Each module 10 more particularly comprises a first half-hull 18A disposed along an internal periphery of the toroidal electrical resistance 1, and a second half-hull 18B disposed along an external periphery of the toroidal electrical resistance 1, the shapes of the first half-hull 18A and the second half-hull 18B being complementary to facilitate their association with one another. The first half-hull 18A and the second half-hull 18B are thus joined along a virtual line corresponding to a main axis of the electrical resistance 1. The first half-hull 18A and the other half-hulls 18 arranged along the internal periphery of the electrical resistance 1 form an internal sub-assembly of half-hulls 18, while the second half-hull 18B and the other half-hulls 18 arranged along the external periphery of the electrical resistance 1 form an external subset of half-hulls 18. The internal and external sub-assemblies comprise nine half-hulls 18 each, making eighteen half-hulls 18 for the electrical resistance 1 taken as a whole.

The half-hulls 18 are associated with each other by means of articulation means 22. Such articulation means 22 are configured to cause a half-hull 18 of the internal sub-assembly to cooperate with a half-hull 18 of the external sub-assembly on the one hand, for example the first half-hull 18A with the second half-hull 18B, and to cause the half-hulls 18 of the internal sub-assembly to cooperate with each other and the half-hulls 18 of the external sub-assembly to cooperate with each other on the other hand. The articulation means 22 comprise a system of blocking teeth associated with pins, the blocking teeth being carried by the half-hulls 18 of the internal sub-assembly, for example, and being arranged in abutment against the pins which are carried by the half-hulls 18 of the external sub-assembly.

Similarly, in the fifth embodiment illustrated in FIGS. 9 to 13, each module 10 is in the form of two half-hulls 18. These half-hulls 18 face each other in a plane of symmetry of the electrical resistance 1 substantially perpendicular to a main plane of elongation of each of the end plates 6, 8. Each module 10 thus comprises a first half-hull 18A arranged on a first side of this plane of symmetry and a second half-hull 18B arranged on a second side of the plane of symmetry. The shapes of the first half-hull 18A and the second half-hull 18B are complementary so as to facilitate their association with each other. In this fifth embodiment, the electrical resistance 1 has four modules 10, each corresponding to a quarter of a toroid, giving a total of eight half-hulls 18. In this fifth embodiment, each half-hull 18 comprises two ribs 17, an internal rib and an external rib. These two internal and external ribs 17 are staggered within a given half-hull 18, so that the internal rib 17 extends beyond the half-hull 18 at one of its ends towards a half-hull 18 adjacent thereto and the external rib 17 extends beyond the given half-hull 18 at the other of its ends, towards another half-hull 18 which is also adjacent thereto.

In this fifth embodiment, the face of the modules 10 dedicated to moving the contact device is, for example, the largest face of the first half-hulls 18A. In this way, the contact device moves along the winding between the internal diameter of the electrical resistance 1 and its external diameter.

In a different way, the modules 10 are annular sections 22 for the second, third, fourth and sixth embodiments. In some embodiments, sixteen annular sections are required to form the electrical resistance 1; however, without departing from the scope of the invention, electrical resistances 1 comprising a different number of annular sections 22 may be envisaged.

These annular sections 22 are joined together by at least one holding member 24. The holding member 24 is used to secure a given module 10 to the module 10 adjacent to it. With the exception of the modules 10 placed against the end plates 6, 8, each module 10 comprises two holding members 24 to secure it to the modules 10 placed on either side of it.

The holding member 24 is shown in FIGS. 3 and 4, with one holding member 24 visible outside the module 10 in FIG. 3 and one holding member 24 visible within a module 10 in each of FIG. 3 and FIG. 4. The holding member 24 is a hook comprising a straight portion and two curved portions at each of its ends. The straight portion of the holding member 24 extends through the thickness of the module 10, i.e. between its external peripheral surface 12 and its internal peripheral surface 16. This straight portion extends between a first edge 26 and a second edge 28 of the module 10, which correspond to its faces facing adjacent modules 10, such edges being arranged in secant planes with respect to an axis of the torus. More particularly, the holding member 24 extends into a chamber 30 formed within the module 10 from its first edge 26 to its second edge 28. The chamber 30 of a given module 10 is arranged opposite the chamber 30 of the module or modules 10 adjacent to it, all the chambers 30 of all the modules 10 forming a channel extending from the first end 2 to the second end 4 of the electrical resistance 1. Each chamber 30 of a given module 10 is also dimensioned to receive two holding members 24, i.e. where applicable the one that connects the given module 10 to the module 10 directly to its right and the one that connects it to the module 10 directly to its left.

The holding member 24 of a given module 10 works in cooperation with a holding member 32 of the adjacent module 10, such a holding member 32 being, for example, a cylinder configured to be housed in the curved portion of the holding member 24. The curved portion of the holding member 24 engages on the holding member 32, then this holding member 32 is positioned in a reception housing 34 provided for this purpose on the edge 26, 28 of the module 10. A rim on the reception housing 34 prevents the holding member 32 from coming out of the reception housing 34. The module 10 having the holding member 24 and the module 10 having the holding member 32 with which the holding member 24 cooperates are held relative to each other by the tension exerted by the holding member 24. In other words, once the holding member 32 is in a predetermined position within its reception housing 32, it puts the holding member 24 under tension and makes the modules 10 secured by forcing them against each other.

In addition to the holding members 24, the assembly of the modules 10 to each other may be made more solid by the presence of at least one safety device. This safety device is, for example, a cable 36 extending within a duct 38 formed in the thickness of the modules 10 from the first end 2 of the electrical resistance 1 to its second end 4. The cable 36 may be seen in FIGS. 6 and 7, while the duct 38 is shown in FIGS. 3, 4, 6 and 7. The electrical resistance 1 comprises, for example, two cables 36, extending respectively along its internal periphery and along its external periphery. The two ducts 38 receiving these cables 36 are arranged substantially equidistant from the chamber 30 within which the holding member 24 extends.

To facilitate assembly of the modules 10, each module 10 has indentations 40 illustrated in FIGS. 2, 3, 4, 9 and 13. These indentations 40 may be triangular in shape, as in FIGS. 2 to 4, or more complex, as in FIG. 9. The indentations 40 are complementary to the indentations 40 of the adjacent modules 10, allowing them to be angularly fitted. In the case of the fifth embodiment shown in FIG. 9, the complex shape of the indentations 40 also allows to hold the modules 10 relative to each other once they have been fitted together. At the junction between two adjacent modules 10, i.e. at the indentations 40, these modules 10 have a reduced cross-section, so that the thickness of the modules 10, measured between the external peripheral surface 12 and the internal peripheral surface 16, is less at the level of the indentations 40 than at a central portion of the modules 10 at a distance from these indentations 40. In other words, the electrical resistance 1 has shoulders bordering each of the modules 10 along their edges 26, 28, so as to form grooves at the level of the indentations 40.

The indentations 40 also prevent the winding 11 from becoming jammed between two adjacent modules 10, by avoiding the straight junction lines into which a turn may sink. The indentations 40 are particularly useful for this purpose when the winding 11 is a round wire. Alternatively, the winding 11 may be a flat ribbon, wound flat against the modules 10 of the electrical resistance 1.

Although the indentation is described in relation to a particular embodiment, the indentation 40 provided on the edge of at least one of the modules is a characteristic applicable to any of the embodiments and all the characteristics and effects described above in relation to the indentation are transposable to any of those embodiments.

In some embodiments, the winding 11 is held in position by covering the modules 10 with a sealing member, for example cement, which smoothes at least the external peripheral surfaces 12 of the modules 10. In order in particular to hold this sealing member around the modules 10, the half-hulls 18 of the first embodiment have ridges 42 extending in line with the external peripheral surfaces 12.

According to the invention, the modules 10 delimit a volume 44 configured for the circulation of the cooling fluid, which depending on the embodiment may be air or water. More specifically, such a volume 44 is delimited by the internal peripheral surfaces 16 of the modules 10, their assembly forming a circulation duct for the cooling fluid. The volume 44 thus extends around the virtual line which forms the main axis of the electrical resistance 1.

Depending on the embodiment, either the cooling fluid circulates directly within the volume 44, being channeled through the internal peripheral portions 16 of the modules 10, or this cooling fluid is channeled through a metal element located within the volume 44. In the second embodiment of FIG. 4, the electrical resistance 1 has no metal element; in the fifth embodiment of FIGS. 9 to 13 and in the sixth embodiment of FIGS. 14 to 16, the metal element takes the form of a metal blade 80; in the other three embodiments, the metal element takes the form of a metal tube 46. In other words, in the presence of a metal element, this takes the form of either a metal blade 80 or a metal tube 46, the latter being in particular continuous.

The metal element is made, for example, of copper, aluminum, beryllium or an alloy of these metals. This metal element extends at least from the first end 2 of the electrical resistance 1 to its second end 4, or even beyond them. It is connected to the aforementioned cooling fluid inlet duct and cooling fluid outlet duct, to ensure the circulation of cooling fluid towards and away from the electrical resistance 1. The metal element is at least partially pressed against at least one of the internal peripheral surfaces 16 of the modules 10; preferably, the metal tube 46 is pressed against all the internal peripheral surfaces 16 of the electrical resistance 1, so that it conforms to at least some of the internal contours of the modules 10.

Among the embodiments wherein the electrical resistance 1 is equipped with a metal element, a distinction is made between variants wherein this metal element is in one-part from the first end 2 to the second end 4 of the electrical resistance 1, and other variants wherein the metal element is the result of an assembly of several parts, i.e. it is composed of a plurality of modular segments 48, 88. The metal element is in one-part in the first and second embodiments shown in FIGS. 1, 2 and 3 respectively, while it is formed of several modular segments 48 in the fourth embodiment shown in FIGS. 5 to 8, in the fifth embodiment shown in FIGS. 9 to 13 and in the sixth embodiment shown in FIGS. 14 to 16.

In the embodiments where the metal element is in one-part, its thermal expansion during heat exchange with the cooling fluid is managed either by inserting a spring-loaded device within the electrical resistance 1, or by connecting this metal tube 46 to only one of the end plates 6, 8.

In the embodiments wherein the metal element comprises several modular segments 48, 88, the thermal expansion is managed in the same way by a spring-loaded device or by spacing the modular segments 48 by a distance corresponding substantially to the expected expansion.

The fourth embodiment will now be described in more detail in relation to FIGS. 5 to 8. In the electrical resistance 1 shown in these figures, each modular segment 48 of the metal tube 46 is associated with a module 10; there is thus an equal number of modular segments 48 and modules 10, i.e. sixteen modular segments 48.

Each modular segment 48 is formed here of several hulls; more particularly, each modular segment 48 consists of two half-hulls 49, such half-hulls 49 being particularly visible in the cross-sectional view of FIG. 7. However, still within the scope of the invention, it would be possible to design modular segments 48 formed by a single annular portion of metal tube 46, an annular portion then being associated with a module 10.

A modular segment 48 comprises an external face 50 and an internal face 52. Its external surface 50 faces the internal peripheral surface 16 of the module 10 with which it is associated. The external surface 50 has a complementary shape to this internal peripheral surface 46, so that it is pressed against it. The internal face 52 is radially opposite the external face 50; it is configured to be in contact with the cooling fluid, the assembly of the internal faces 52 of each of the modules 10 from the first end 2 to the second end 4 of the electrical resistance 1 allowing to delimit a cooling fluid circulation duct along the entire length of the electrical resistance 1.

The external face 50 and internal face 52 of a given modular segment 48 are connected to each other by wafers 54, 56, i.e. a first wafer 54 and a second wafer 56, which axially delimit the modular segment 48. The first wafer 54 of the modular segment 48 is arranged in the vicinity of the first edge 26 of the module 10 with which it is associated, while its second wafer 56 is arranged in the vicinity of the second edge 28 thereof.

As may be seen particularly clearly in FIGS. 7 and 8, each modular segment 48 comprises securing means. As part of these securing means, each modular segment 48 has at least one leg 58 and at least one recess 60, both of which are formed from one of its wafers 54, 56. In the embodiment illustrated here, each modular segment 48 comprises four legs 58 and four recesses 60 formed from its first wafer 54, as well as four legs 58 and four recesses 60 formed from its second wafer 56. The legs 58 on the same wafer 54, 56 have different orientations with respect to a central axis of the metal tube 46, such a central axis being coincident with the virtual line which forms the axis of the electrical resistance 1.

The leg 58 is L-shaped, as may be seen in FIG. 7, and the recess 60 is substantially rectangular. The leg 58 and the recess 60 have complementary shapes; it is understood that the leg 58 of a given modular segment 48 is configured to fit within the recess 60 of an adjacent modular segment 48. These complementary shapes of the legs 58 and the recesses 60 in the modular segments 48 allow them to be held together. This type of assembly, which means that the modular segments 48 are connected at pinpoint areas rather than along their wafers 54, 56, facilitates the thermal expansion of the metal tube 46.

In the fourth embodiment, the electrical resistance 1 comprises at least one attachment flange 62. The flange 62 is annular in shape and is particularly visible in FIG. 8. It is made of metal, so as to ensure thermal conduction between the modular segments 48. The flange 62 is annular in shape and substantially flat; it extends radially between an external wall 64 and an internal wall 66, this internal wall 66 being its wall which is closest to the central axis of the metal tube 46.

The flange 62 is arranged between two adjacent modular segments 48, so that it forms a spacer between the modular segments 48. The flange 62 extends axially between a first contact face disposed against the second wafer 56 of a given modular segment 48 and a second contact face disposed against the first wafer 54 of the adjacent modular segment 48. The flange 62 also extends between two adjacent modules 10, so that its first contact face is against the second edge 28 of a given module 10, while its second contact face is against the first edge 26 of the adjacent module 10.

The flange 62 is dimensioned so that its external wall 64 is arranged radially between the external peripheral surfaces 12 and the internal peripheral surfaces 16 of two adjacent modules 10, as may be seen in particular in FIG. 7. It is understood from the above that a circumference of the external wall 64 of the flange 62 is greater than a circumference of the internal peripheral surface 16 of the module 10, but less than a circumference of the external peripheral surface 12 of this module 10. The circumference of the external wall 64 of the flange 62 is also greater than both a circumference of the external face 50 of the modular segment 48 and a circumference of its internal face 52.

As the flange 62 is arranged between two modular segments 48, a solid flange 62 would constitute a physical obstacle to the connection of these modular segments 48. At least one slot 68 is therefore provided in the flange 62 to allow connection between the two modular segments 48 arranged on either side of this flange 62. As may be seen in FIG. 8, the flange 62 comprises eight slots 68, i.e. four slots 68 configured to receive the four legs 58 of each of the two modular segments 48 between which it is arranged. It is understood that the leg 58 of a modular segment 48 extends through the flange 62 by being housed through one of its slots 68.

The relative positions of the modular segment 48 and the flange 62 are locked by a rotation of the flange 62, this rotation bringing the modular segment 48 closer to the internal peripheral surface 16 of the module 10 with which it is associated. Such locking between the modular segment 48 and the flange 62 is facilitated by the L-shape of the leg 58, this L-shape allowing bayonet-type attachment within the slot 68. The different orientations between the legs 58 of the same modular segment 48 also help to press the modular segment 48 against the module 10.

A sealing member such as the one described above may be placed in a space 68 delimited by the external wall 64 of the flange 62 and the edges 26, 28 of the modules 10 which frame it. The sealing member then holds the flange 62 in position relative to the modules 10, preventing it from rotating once it is correctly positioned within the electrical resistance 1.

The metal element of the fifth embodiment will now be described in relation to FIGS. 9 to 13. As mentioned above, in this fifth embodiment the electrical resistance 1 is generally toroidal in shape. The electrical resistance 1 thus lies within a circle that defines its overall axis of extension.

It should also be noted that at least one of the modules, and advantageously all the modules, in this embodiment illustrated in FIGS. 9 to 13 extends along an arc of a circle. Each module is therefore a portion of a curve.

Here, the metal element is in the form of at least one spring-loaded metal blade 80. More particularly, the metal element comprises two metal blades 80 with an internal blade 80A facing the internal diameter of the electrical resistance 1 and an external blade 80B facing its external diameter. Each blade 80 extends from the first end 2 of the electrical resistance 1 to its second end 4, i.e. from the first end plate 6 to the second end plate 8.

The blade 80 has a generally circular arc shape, which follows the generally toroidal shape of the electrical resistance 1. The blade 80 comprises a central area 82 surrounded by two peripheral areas 84, all three areas extending from the first end 2 to the second end 4 of the electrical resistance 1. The central area 82 and the peripheral areas 84 are illustrated in FIGS. 10 to 12.

A body of the blade 80 extends in two intersecting planes, so that the central area 82 is closer to the internal diameter of the electrical resistance 1 than the two peripheral areas 84. As may be seen in FIG. 11, there is an angle between a plane wherein the first peripheral area 84 mainly extends and a plane wherein the second peripheral area 84 mainly extends, such an angle being, for example, between 70° and 85°.

The blade 80 is at least partially in contact with the modules 10; more particularly, for a given module 10, one face of one of the peripheral areas 84 is in contact with one of the ribs 17 present on the internal peripheral surface 16 of the first half-hull 18A and one face of the other peripheral area 82 is in contact with the rib 17 present on the complementary second half-hull 18B. The thermal exchanges between the cooling fluid on the one hand and the modules 10 on the other, which takes place through the blade 18, thus takes place along the two peripheral portions. As the blade 80 is a spring-loaded blade, it generates pressure against the ribs 17.

The central area 82 is arranged between the rib 17 of the first half-hull 18A and the rib 17 of the second half-hull 18B, without being in contact with them. At least one opening 86, in this case a plurality of openings 86, is formed within the central area 82. The opening 86 is rectangular in shape and facilitates the circulation of cooling fluid on either side of the blade 80.

Depending on the embodiments, the blade 80 is either made in one-part or comprises a plurality of modular segments. In the fifth embodiment, these modular segments take the form of slats 88. These slats 88 are pieces of the blade 80 which are arranged end to end from the first end 2 to the second end 4 of the electrical resistance 1. For a given blade 80, a slat 88 is associated with a module 10; if there are two blades 80 within the volume 44, there are therefore two slats 88 per module 10, with a shorter slat 88 facing the internal diameter of the electrical resistance 1 and a longer slat 88 facing its external diameter. The electrical resistance 1 thus comprises eight slats 88. In addition to the slats 88 arranged within the modules 10, the electrical resistance may comprise additional slats that are smaller in size than the slats 88. These additional slats, not visible in the figures, form a connection between the slats 88 on the one hand and either the cooling fluid inlet duct or the cooling fluid outlet duct on the other, the additional slats passing through the end plates 6, 8 which are connected to these cooling fluid inlet and outlet ducts.

Each slat 88 of the blade 80 extends between a first wafer 54 directed towards the first end 2 of the electrical resistance 1 and a second wafer 56 directed towards the second end 4 of this electrical resistance 1. The first wafer 54 and the second wafer 56 of each slat 88 are equipped with securing means, particularly visible in FIGS. 12 and 13. Such securing means help to join the slat 88 either to an adjacent slat 88 or to an additional slat at the end plates 6, 8. Thus, the slats 88 associated with modules 10 adjoining the end plates 6, 8 have securing means directed towards an additional slat at one of their longitudinal ends and securing means directed towards a slat 88 adjoining the other of their wafers 54, 56, whereas the slats 88 associated with modules 10 disposed at a distance from the end plates 6, 8 comprise securing means directed towards slats 88 adjoining their two wafers 54, 56.

More specifically, the securing means comprise at least one substantially flat arm 92 and a hook 94, with, for example, an arm 92 arranged on the first wafer 54 and a hook 94 arranged on the second wafer 56 of the slat 88. Each slat 88 comprises two arms 92 and two hooks 94 distributed between the two wafers 54, 56, with one arm 92 and one hook 94 for each peripheral area 84. The arm 92 is similar to the leg 58 in the fourth embodiment.

In order to facilitate assembly between two adjacent slats 88 or between a slat 88 and a further slat, in the fifth embodiment the electrical resistance 1 comprises at least one attachment flange 62. More specifically, the electrical resistance 1 has an attachment flange 62 at each wafer 54, 56 of the slats 88; in other words, an attachment flange 62 is interposed between the bodies of two adjacent slats 88. As a result, at least some of the attachment flanges 62 are positioned opposite the indentations 40 at the junction between the modules 10. As may be seen in FIG. 10, the securing means extend at least partially through the attachment flange 62.

The attachment flange 62 is generally square when the cross-section of the electrical resistance 1 is square, as is the case in the fifth embodiment. It is substantially flat and extends mainly in a plane perpendicular to the virtual line forming the axis of the electrical resistance 1. The attachment flange 62 is used to connect two slats 88 on the one hand, and to connect these slats 88 to the modules 10 on the other. To this end, the attachment flange 62 comprises at least one holding finger 98 which extends in the plane perpendicular to the virtual line forming the axis of the electrical resistance 1. This holding finger 98 cooperates with the arm 92 and the hook 94 of the slats 88, the hook 94 being in abutment against the holding finger 98. Each attachment flange 62 comprises four holding fingers 98, i.e. two holding fingers 98 for the internal blade 80A and two holding fingers 98 for the external blade 80B. As the blade 80 is a spring-loaded blade, it presses on the attachment flange 62 to press it against the modules 10 and thus helps to hold the electrical resistance 1 in place. A cooperative arrangement between a slat 88 and two attachment flanges 62 is shown in FIG. 12, with arrows illustrating the cooperation between the means of securing the slat 88 and the holding fingers 98 of the attachment flanges 62.

The electrical resistance 1 according to the invention will now be described according to a sixth embodiment illustrated in FIGS. 14 to 16. The electrical resistance 1 is formed here, for example, by six modules 10 arranged side by side from the first end 2 to the second end 4. The modules 10 extend between the two end plates 6, 8, which are connected to each other outside the modules 10 by a metal structure 96.

Each module 10 contains a plurality of metal elements in the form of folded metal blades 80 which help to channel the cooling fluid. In terms of these metal blades 80, the electrical resistance 1 comprises at least one slide 100 and one gutter 102 for each module 10. More specifically, the electrical resistance 1 has a single slide 100 and two gutters 102 for each module 10. A modular segment of the metal element is thus formed by an assembly comprising the slide 100 and the two gutters 102.

The slide 100 is a profiled slide, as shown in FIG. 16. It is “U”-shaped, consisting of a bottom 104 bordered by two arms 106, only one of these arms 106 being visible in FIG. 16. The two arms 106 extend mainly in substantially parallel planes. The two arms 106 extend mainly in planes substantially perpendicular to the bottom 104.

The free ends of the arms 106, which correspond to their ends furthest from the bottom 104, are pressed against the internal peripheral surface 16 of the module 10 over an entire longitudinal dimension of the slide 100. Such contact between the free ends of the arms 106 and the internal peripheral surface 16 of the module 10 promotes heat transfer between these elements. The “U” shape of the slide 100 also facilitates the channeling of the cooling fluid, which circulates in particular within a space delimited by the bottom 104, the two arms 106 and an internal peripheral half-surface 16 of the module 10.

At each longitudinal end of the slide 100, i.e. at each edge or wafer 54, 56 of a given modular segment, a notch 108 is formed in the bottom 104. This notch 108, which may be seen in FIG. 16, is complementary in shape to a free end of an attachment crosspiece 110, the latter provides a mechanical connection between the various modules 10 and between the various modular segments and which will be described later.

The bottom 104 also has at least one orifice through which an attachment means 112, such as a screw or rivet, may pass. This attachment means 112 is used to secure the slide 100 to the gutters 102 and to secure the gutters 102 to each other.

Each gutter 102 is L-shaped, with a contact wall 114 extending substantially parallel to the bottom 104 of the slide 100 and a free wall 116 extending in a plane intersecting the contact wall 114. Between them, the contact wall 114 and the free wall 116 form an obtuse angle, for example.

The contact walls 114 of the two gutters 102 are superimposed, so that one of the contact walls 114 is arranged between the other contact wall 114 and the bottom 104 of the slide 100. The contact wall 114, which is arranged between the other contact wall 114 and the bottom 104 of the slide 100, is also pressed against this bottom 104. In this way, the attachment means 112 passes through both the bottom 104 of the slide 100 and the contact wall 114 of each of the gutters 102.

When the two gutters 102 are assembled together, they have a U-shaped cross-section when viewed perpendicularly to the main direction of elongation of the module 10. This is because the two gutters 102 are assembled in such a way that their free walls 116 are opposite each other on either side of the superposition formed by the two contact walls 114. It is clear from the above that the cooling fluid is channeled, in addition to the “U” shape of the slide 100, by the “U” shape resulting from the superposition of the two gutters 102. Finally, the cooling fluid is channeled on the one hand into a space delimited at least by the internal periphery 16 of the module 10 and by one of the arms 106 of the slide 102 and the free wall 116 of one of the gutters 102, and on the other hand in a space delimited at least by the internal periphery 16 of the module 10 and by the other arm 106 of the slide 102 and the free wall 116 of the other gutter 102.

Similar to the notches 108 in the slides 100, cuts 118 are provided at each longitudinal end of the free walls 116 of the gutters 102, so as to cooperate with the attachment crosspiece 110.

In the sixth embodiment, contact between the free ends of the arms 106 of the slide 100 is ensured by means of a spring element 120. This spring element 120 extends from one wafer 54, 56 to the other of the modular segment. The spring element 120 has a central angled portion 122 which is arranged between two flared portions 124. One of the flared portions 124 is disposed at the first wafer 54 of the modular segment while the other flared portion 124 is disposed at the second wafer 56 of the modular segment. The central portion 122 bears against the contact wall 114 of one of the gutters 102; so when, due to the spring effect of the spring element 120, the central portion 122 pushes against the contact wall 144, this pushing force is transmitted to the slide 100 which is then pressed against the internal peripheral surface 16 of the module 10. In one embodiment, the spring element 120 is a spring blade. The stress generated by the spring element 120 may result from a bend comprised in the central portion 122.

At the junction between two modular segments, the attachment crosspiece 110 is used to secure the various elements forming the electrical resistance 1. The attachment crosspiece 110 comprises four branches 126 which are arranged at right angles to each other and meet at a central point 128. The attachment crosspiece 110 is thus, for example, a cross, for example with branches of identical length.

The notch 108 in the slide 100 cooperates with one of the branches 126, while the cuts 118 in the gutters 102 each cooperate with a branch 126 adjacent to the branch 126 which cooperates with the notch 108. The last of the four branches 126 does not cooperate with the slide 100 and the gutters 102, but its free end is housed in a reception area 32.

One of the flared portions 124 of the spring element 120 cooperates with the attachment crosspiece 110 at its central point 128. More specifically, as may be seen in FIG. 16, the central point 128 of the attachment crosspiece 110 has an attachment element 130 passing through it, which also passes through the flared portion 124. The attachment element 130 is, for example, an assembly formed by at least one bolt made up of a screw and a nut, possibly together with a locknut.

The attachment crosspiece 110 helps to ensure that two adjoining modules 10 are secured together. It is therefore an alternative to the attachment flange 62 of the fourth embodiment and forms an attachment system between two adjacent modules 10. The attachment crosspiece 110 is arranged between two adjacent modules 10.

In order to avoid creating too great a space between two adjacent modules 10 due to the presence of the attachment crosspiece 110, areas 132 for receiving the free ends of the branches 126 of the attachment crosspiece 110 are provided within the modules 10. These reception areas 132 are recesses formed radially from the internal peripheral surface 26 towards the external peripheral surface 12, and axially from the edges 26, 28 of the modules. Each of these reception areas is a notch in the module.

In this way, the attachment crosspiece 110 extends axially between a first contact face at least partially embedded in the second edge 28 of a given module 10 and a second contact face at least partially embedded in the first edge 26 of the adjacent module 10, said contact face forming a bottom of the notch.

The attachment crosspiece 110 is dimensioned so that free ends of its branches 126 extend radially between the external peripheral surfaces 12 and the internal peripheral surfaces 16 of two adjacent modules 10. It is understood from the above that a circumference of the attachment crosspiece 110 passing through the free ends of its four branches 126 is strictly greater than a circumference of the internal peripheral surface 16 of the module 10, but strictly less than a circumference of the external peripheral surface 12 of this module 10.

The metal structure 96 connecting the two end plates 6, 8 of the electrical resistance 1 in the sixth embodiment will now be described in relation to FIG. 14. The metal structure 96 joins the first end 2 of the electrical resistance 1 and its second end 4; in other words, the metal structure 96 forms a mechanical connection between the two ends 2, 4 of the electrical resistance 1.

In addition to the connection between the two end plates 6, 8, the metal structure 96 also provides a connection with the cooling fluid inlet duct and the cooling fluid outlet duct to which the end plates 6, 8 are connected.

The cooling fluid inlet and outlet ducts, like the metal structure 96, are electrically insulated from the metal element, which in this sixth embodiment is formed in particular by the slides 100 and the gutters 102. To do this, the electrical resistance according to the invention may comprise an electrical insulation device, the latter may take the form of at least one insulating platelet 134 interposed between the attachment crosspiece 110 closest to one of the end plates 6, 8 and this end plate 6, 8. The electrical resistance 1 may also comprise another insulating platelet 134 between the end plate 6, 8 and the cooling fluid circulation duct. This insulating platelet 134 extends, for example, in a plane perpendicular to an axis of the cooling fluid circulation duct. The insulating platelet 134 is made of mica or epoxy, for example. It should be noted that the attachment elements, in this case screws, which pass through the end plates are also surrounded by an electrically insulating element, for example mica rings. Similarly, the electrical resistance 1 may comprise cover platelet 136 which reinforce the connection between the metal structure 96 and the rest of the electrical resistance 1, these cover platelet 136 also being made of an electrically insulating material.

According to the invention, the electrical resistance 1 comprises at least one heat transfer device 70 configured to improve thermal exchange between the winding 11 and the cooling fluid. This heat transfer device 70 extends at least partially within the volume 44 delimited by the modules 10; depending on the embodiment, it is either partially arranged within this volume 44 and partially arranged in the thickness of the module 10, or arranged entirely within the volume 44.

In the fifth embodiment shown in FIGS. 9 to 13, the heat transfer device 70 corresponds to the bodies of the slats 88 which form the modular segments of the metal blade 80. In the sixth embodiment shown in FIGS. 14 to 16, the heat transfer device 70 comprises, in particular, the slides 100 and the gutters 102 which form the modular segments of the metal element.

In the second embodiment shown in FIG. 3 and in the fourth embodiment shown in FIGS. 6 to 8, the electrical resistance 1 comprises, as its heat transfer device 70, at least one fin 72 arranged within the metal tube 46. This fin 72 is for example a metal platelet, in particular a copper platelet, which is arranged radially in the metal tube 46. There are four substantially straight fins 72 in the second embodiment, while there are eight curved fins 72 in the fourth embodiment. In this fourth embodiment, the fins 72 comprise a first portion 72A extending radially within the metal tube 46 towards the central axis thereof, and a second portion 72B curved so as to be in contact with the metal tube 46 and more specifically in contact with its internal face 52 with a view to improving thermal exchange.

In the second embodiment shown in FIG. 3, the electrical resistance 1 also comprises at least one folded flank 74 as the heat transfer device 70. This folded flank 74 has a first segment 74A in contact with the metal tube 46 and more particularly its external face 50, as well as a second segment 74B arranged in the thickness of the module 10. More specifically, the second segment 74B is arranged in a cavity 76 formed in the thickness of the module 10 between its external peripheral surface 12 and its internal peripheral surface 16. The first segment 74A is pressed against the metal tube 46 and the second segment 74B is pressed against a wall of the cavity 76, the folded flank 74 being compressed so as to be inserted into the cavity 76. The module 10 comprises eight cavities 76, with four cavities 76 formed from its first edge 26 and four cavities 76 formed from its second edge 28. Each cavity 76 is configured to house the second segment 74B of a folded flank 74, so that each module 10 is associated with eight folded flanks 74. The cavities 76 are arranged within the module 10 between the chambers 30 configured to receive the holding members 24 and the ducts 36 for the cables 36, which also help to hold the modules 10 together.

In the third embodiment shown in FIG. 4, the heat transfer device 70 takes the form of at least one tongue 78. The tongue 78 comprises a first substantially flat part 78A which extends radially within the volume 44 delimited by the internal peripheral surfaces 16 of the modules 10, and a second corrugated part 78B which extends within a cavity 76 provided to receive it in the thickness of the module 10. In this third embodiment, the heat transfer device 70 comprises eight tongues 78 arranged at regular intervals within the module 8.

A method for assembling the electrical resistance 1 will now be described. This assembly method begins with a step wherein the modules 10 are cut from a tube of electrically insulating material. The resulting modules 10 have parallel edges 26, 28 if the electrical resistance 1 has a generally rectilinear shape, or edges 26, 28 extending in intersecting planes if it has a generally toroidal shape.

In the fourth embodiment, the assembly method also comprises a step of cutting the modular segments 48 from a metal tube or blade; in the same way as for the modules 10, the modular segments 48 have, in the case of a metal tube 46, parallel wafers 54, 56 if the electrical resistance 1 has a generally rectilinear shape, whereas they have wafers 54, 56 extending in intersecting planes if its general shape is toroidal.

After the step of cutting the modules 10, the assembly method comprises a step of assembling these modules 10. This assembly step corresponds to a step wherein the modules 10 are assembled together. In the first, second, fourth, fifth and sixth embodiments, it also comprises a sub-step of assembling the modules 10 to the metal element, i.e. to the metal tube 46 or to the metal blade 80.

In the sixth embodiment, the step of assembling the modules 10 comprises a sub-step of assembling the slide 100 to the gutters 102, so as to form the metal element. The slide 100 and the gutters 102 are secured to each other by means of attachment means 112 which pass through them. Once secured, the slide 100 and the gutters 102 are inserted into a given module 10, entering its internal volume through one or other of the edges 26, 28 of the module 10, then the spring element 120 is also placed within the module 10. The attachment crosspieces 110 are inserted into the reception areas 132 formed in the edges 26, 28 of the modules 10. If necessary, a sealing member may first be deposited within these reception areas 132 and/or on the wafer of the module formed by the edge 26, 28, in order to improve the mechanical holding of the electrical resistance 1 and to perfect its sealing with respect to the cooling fluid.

The complementary shapes of the notch 108 in the slide 100 and the cuts 118 in the gutters 102, on the one hand, and the branches 126 of the attachment crosspiece 110, on the other, ensure that they are correctly positioned. The spring element 120 is then secured to the attachment crosspiece 110 by means of the attachment element 130.

During the assembly step, the modules 10 are arranged side by side, if necessary around the metal tube 46 or the metal blade 80, and are secured together at the level of their indentations 40 or more generally at their edges 26, 28. The sub-step of assembling the modules 10 to the metal element is characterized, when this metal element is in the form of modular segments 48 as is the case in the fourth, fifth and sixth embodiments, by pressing at least partially a given modular segment 48 against the internal peripheral surface 16 of the module 10 with which it is associated. For the metal tube 46, such pressing results from the rotation of a flange 62 with respect to the modular segment 48, as explained above. In the case of the metal blade 80 of the fifth embodiment, the pressing takes place along a rib 17 forming a projection within an internal peripheral surface 16. For the metal element of the sixth embodiment, which corresponds to the assembly formed by the slide 100 and the gutters 102, the pressing is made possible by the spring element 120 which presses, at its central portion 122, on the gutters 102 which themselves press on the slide 100, the latter coming into contact with the internal peripheral surface 16 of the corresponding module 10. The assembly step also comprises a sub-step for positioning the at least one heat transfer device 70, such a positioning sub-step being prior to assembling the modules 10 together. This heat transfer device 70 may be positioned within the metal tube 46.

Alternatively or additionally, and in particular in the context of the second embodiment of the electrical resistance 1, the cavity 76 configured to receive this heat transfer device 70 is filled with a sealing member, by injection by syringe for example, then the heat transfer device 70 is inserted within the sealing member in a compressed form so as to be pressed optimally against the cavity 76 when it is released.

Once the heat transfer device 70 is in position, the modules 10 are joined end-to-end. To this end, the modules 10 cooperate via their articulation means 22 in the first embodiment, or by means of their holding members 24 as previously described in relation to the fourth embodiment or attachment crosspieces 110 as detailed in relation to the sixth embodiment. Each module 10 is thus assembled with at least one adjacent module 10, and possibly with one of the end plates 6, 8.

Once the modules 10 have been assembled, the assembly method continues, in some embodiments, with a step wherein the modules 10 are covered by the sealing member. The sealing member is deposited in a layer around the external peripheral surfaces 12 of the modules 10, as well as in the space 68 delimited by a flange 62 and two adjacent modules 10 for the fourth embodiment. The covering step may comprise a smoothing sub-step to obtain a surface of the electrical resistance 1 suitable for receiving the winding 11.

The assembly method ends with a winding step during which the winding 11 is wound in turns around the modules 10, or even around the sealing member if necessary. The winding 11 has a binding effect around the modules 10, holding their half-hulls 18 in position when these modules 10 are not in one-part. A new covering step may take place to cover the winding 11 with a new layer of sealing member. As mentioned previously, in some embodiments the modules 10 have grooves at the level of their indentations 40. The sealing member then penetrates into the grooves and allows the adjoining modules 10 to be joined together so as to reinforce the assembly of the electrical resistance 1. Either the modules 10 have grooves on all of their external peripheral surfaces 12, or the external peripheral surfaces 12 have no grooves on both the side that receives the contact device and the side opposite it, or these external peripheral surfaces 12 have no grooves on the flat portion 14 provided for the movement of this contact device. In addition, at the interfaces between the modules 10 and the end plates 4, 6, the sealing member is inserted within the portion provided with open areas of the metal collars which ensure the electrical contacts between the modules 10 and the end plates 4, 6. The sealing member passes through these open areas, reaching the grooves and filling them.

The present invention thus offers a modular electrical resistance for which heat dissipation management is facilitated by the presence of a volume configured for the circulation of a cooling fluid within the electrical resistance.

However, the present invention is not limited to the means and configurations described and illustrated herein, and also extends to any equivalent means and configurations, as well as to any technically operative combination of such means.

1. An electrical resistance of generally toroidal shape extending between a first end and a second end, comprising a plurality of modules made of an electrically insulating material and a winding wound in turns around the modules, each of the modules having an external peripheral surface and an internal peripheral surface, the modules being arranged side by side from the first end to the second end of the electrical resistance defining a volume configured for the circulation of a cooling fluid.

2. The electrical resistance as claimed in claim 1, comprising a contact device bearing against the winding and movable between the first end and the second end of the electrical resistance.

3. The electrical resistance according to claim 1, comprising a metal element arranged within the volume delimited by the modules, the metal element being configured to channel the cooling fluid.

4. The electrical resistance according to claim 3, wherein the metal element is at least partially pressed against at least one of the internal peripheral surfaces of the modules.

5. The electrical resistance according to claim 1, further comprising a metal element arranged within the volume delimited by the modules, the metal element being configured to channel the cooling fluid, wherein the metal element is composed of a plurality of modular segments.

6. The electrical resistance according to claim 1, further comprising a metal element arranged within the volume delimited by the modules, the metal element being configured to channel the cooling fluid, wherein the metal element is a metal tube.

7. The electrical resistance as claimed in claim 3, wherein the metal element is a metal blade.

8. The electrical resistor as claimed in claim 3, wherein the metal element is formed by an assembly comprising at least one slide and at least two gutters.

9. The electrical resistance according to claim 1, further comprising a metal element arranged within the volume delimited by the modules, the metal element being configured to channel the cooling fluid,
wherein the metal element is composed of a plurality of modular segments, and
wherein each modular segment is associated with a module.

10. The electrical resistance as claimed in claim 9, wherein at least one of the modular segments is delimited axially by a first wafer and a second wafer, the modular segment comprising securing means formed from at least one of the wafers.

11. The electrical resistance according to claim 1, comprising an attachment system which mechanically connects two adjacent modules.

12. The electrical resistance according to claim 11, further comprising a metal element arranged within the volume delimited by the modules, the metal element being configured to channel the cooling fluid,
wherein the metal element is composed of a plurality of modular segments, and
wherein the attachment system comprises an attachment flange disposed at a junction between two adjacent modular segments, the securing means extending at least partially through this attachment flange.

13. The electrical resistance as claimed in claim 11, wherein the attachment system comprises an attachment crosspiece disposed at a junction between two adjacent modules.

14. The electrical resistance according to claim 7,
wherein the metal element is a metal blade, and
wherein at least one opening is provided within the metal blade

15. The electrical resistance according to claim 3, wherein the metal element is formed in one-part from the first to the second end of the electrical resistance.

16. The electrical resistance according to claim 1, comprising at least one heat transfer device which extends at least partly within the volume delimited by the modules.

17. The electrical resistance according to claim 1, wherein at least one of the modules is composed of at least two hulls.

18. The electrical resistance according to claim 1, wherein the modules are annular sections.

19. The electrical resistance according to claim 1, wherein the overall toroidal shape of the electrical resistance is square in cross-section.

20. The electrical resistance according to claim 1, wherein at least one of the modules has indentations complementary to an adjacent module.

21. The electrical resistance according to claim 1, comprising a first end plate associated with the first end and a second end plate associated with the second end.

22. A method for assembling an electrical resistance according to claim 1, comprising a step of assembling the modules during which the modules are butt-jointed and a winding step during which the winding is wound in turns around the modules.
